(19) United States
(12) Patent Application Publication
(10) Pub. No.: US 2009/0249861 A1
(43) Pub. Date: Oct. 8, 2009

(54) STABLE PHOTO ACOUSTIC TRACE GAS DETECTOR WITH OPTICAL POWER ENHANCEMENT CAVITY

(75) Inventors: Erik Martinus Hubertus Petrus Van Dijk, Eindhoven (NL); Jeroen Kalkman, Utrecht (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/438,571

(22) PCT Filed: Aug. 31, 2007
(86) PCT No.: PCT/IB2007/053518

§ 371 Date: Feb. 24, 2009

(30) Foreign Application Priority Data
Aug. 31, 2006 (EP) 06119849.5

(51) Int. Cl. G01N 21/00

(52) U.S. Cl. 73/24.02

(57) ABSTRACT

A photo acoustic trace gas detector (100) is provided for detecting a concentration of a trace gas in a gas mixture. The photo acoustic trace gas detector (100) comprises a light source (101), an optical cavity (104a, 104b), ratio modulating means (105, 111) and a transducer (109). The optical cavity (104a, 104b) contains the gas mixture and amplifies light intensity. Maximum amplification is provided when a ratio of a wavelength of the light beam and a length of the optical cavity (104a, 104b) has a resonance value. Ratio modulating means (105, 111) modulate the ratio for transformation of the light beam into a series of light pulses for generating the sound waves, an amplitude of the sound waves being a measure of the concentration of the trace gas. A transducer (109) converts the sound waves into electrical signals.

### TECHNICAL FIELD OF THE INVENTION

The invention relates to a photo acoustic trace gas detector for detecting a concentration of a trace gas in a gas mixture, the photo acoustic trace gas detector comprising a light source for producing a light beam, an optical cavity for containing the gas mixture and for amplification of a light intensity of the light beam, the optical cavity providing a maximum amplification when a ratio of a wavelength of the light beam and a length of the optical cavity has a resonance value, ratio modulating means for modulating the ratio, and a transducer for converting sound waves in the gas mixture into electrical signals.

### BACKGROUND OF THE INVENTION

Such a detector is known from the article “Optical enhancement of diode laser-photo acoustic trace gas detection by means of external Fabry-Perot cavity” by Rossi et al., published in Applied Physics Letters. The detector described therein sends a chopped laser beam through a gas contained in an acoustic cell. The laser beam is chopped by a rotating disc chopper that periodically interrupts the light beam. The laser wavelength is tuned to excite particular molecules of the gas into a higher energy level. This excitation leads to an increase of the thermal energy, resulting in a local rise of the temperature and the pressure inside the acoustic cell. If the chopping frequency matches a resonance frequency of the acoustic cell, the pressure variations result in a standing acoustic wave. These acoustic waves are detected by a microphone in the acoustic cell. The resonance frequency of such an acoustic cell is typically of the order of a few kHz. In the detector of Rossi et al., a chopping frequency of 2.6 kHz is used.

Rossi et al. also describe using a Fabry-Perot cavity for amplifying the light intensity in the acoustic cell by locking the laser wavelength to the cavity length. The amplification is very advantageous because the sensitivity of the detector is proportional to the laser power. A feedback signal is obtained from a photodiode placed behind the Fabry-Perot cavity. In order to produce the feedback signal, the laser wavelength is weakly modulated by adding a small sinusoidal waveform to the power supply current. The laser beam passes through the optical cavity and is focalized on the photodiode. The photo-diode signal is then used for feedback on the laser wavelength, in order to lock the laser wavelength to the cavity length.

An important application of photo acoustic trace gas detectors is breath testing. Breath testing is a promising area of medical technology. Breath tests are non-invasive, user friendly and low cost. Prime examples of breath testing are monitoring of asthma, alcohol breath testing and detection of stomach disorders and acute organ rejection. First clinical trials show possible applications in the pre-screening of breast and lung cancer. These volatile biomarkers have typical concentrations in the parts per billion (ppb) range. Nitric oxide (NO) is one of the most important trace gases in the human breath, and elevated concentrations of NO can be found in asthmatic patients. Currently, exhaled NO levels at ppb concentrations can be only measured using expensive and bulky equipment based on chemiluminescence or optical absorption spectroscopy. A compact, hand-held, and low-cost NO sensor forms a useful device that can be used to diagnose and monitor airway inflammation and can be used at the doctor's office and for medication control at home.

It is the challenge for these hand-held gas-analyzing devices to combine sufficient high sensitivity (ppb level) with small portable devices with a simple design and a high robustness. Current photo acoustic trace gas detectors have the disadvantage that small form factor lasers (i.e. diode lasers) do not have sufficient laser power to reach the sensitivity required for trace gas detection. The use of an optical power enhancement cavity as described by Rossi et al. could increase the optical power. However, the design of Rossi et al. is not easily scalable to a portable dimension, while preserving high robustness.

### SUMMARY OF THE INVENTION

It is an object of the invention to provide a photo acoustic trace gas detector according to the opening paragraph with a simpler design.

According to a first aspect of the invention, this object is achieved by providing a photo acoustic trace gas detector according to the opening paragraph, wherein the ratio modulating means are arranged for modulating the ratio for transformation of the light beam into a series of light pulses for generating the sound waves, an amplitude of the sound waves being a measure of the concentration of the trace gas.

By modulating the ratio, the amplification of the light intensity in the optical cavity is also modulated. Each time the ratio has the resonance value, the amplification is maximal. When the ratio is far away from the resonance value, the amplification is minimal. The range for the modulation of the ratio is chosen large enough to generate light pulses with a light intensity that is sufficient for generating sound waves in the gas mixture. The sound waves must have enough amplitude to enable deriving the concentration of the trace gas there from. The amount of sound generated depends on the concentration of the trace gas of interest. Preferably the ratio is modulated such that the amplification varies between minimal and maximal amplification. The higher the amplitude of the modulation of the light intensity, the higher the accuracy of the trace gas detection. The photo-acoustic detector according to the invention does not need a chopper, but uses the intrinsic properties of the cavity to modulate the excitation power in the cavity instead of a chopper. This leads to a simpler design that requires fewer components and less moving parts.

Preferably, the ratio modulating means are arranged for modulating the ratio around the resonance value. During each period of the modulation, the resonance value is obtained twice; once when increasing the ratio and once when decreasing the ratio. Consequently, when modulating the ratio with a frequency f around the resonance value, light pulses are generated in the optical cavity with a frequency 2f. The photo acoustic signal will also be generated at the frequency 2f. It is an advantage of the modulation around the resonance value that the power in the cavity will be high and the photo acoustic signal will be strong.

In a preferred embodiment, the detector further comprises a feed back loop for regulating the amplification, the feedback loop comprising a photo detector for measuring the light intensity of the light pulses, and adjusting means coupled to the photo detector and to the ratio modulating means for, in dependence of the measured light intensity, adjusting an average of the ratio such that the modulation is performed substantially symmetrically around the resonance value.

With this embodiment, the ratio is kept symmetric around the optimum value and the light pulses are created at regular time intervals. As a result, also the pressure variations in the gas mixture are generated at regular time intervals thereby aiding the trace gas detection.

Preferably, the adjusting means are arranged for calculating frequency components of the measured light intensity. By calculating frequency components of the measured light intensity, the amplitude components of the transmitted signal at multiples of the modulation frequency f are determined. If the modulation is performed exactly symmetrically around the optimum value, light pulses are generated at regular time intervals at a frequency 2f and the photodiode signal will only comprise amplitude components at the even multiples of the modulation frequency, f (2 f, 4 f, . . . , 2 n f). If the modulation is not performed exactly symmetrically around the optimum value, also odd multiples of frequency f (1 f, 3 f, . . . , (2n+1) f) will be comprised in the photodiode signal. These odd frequency components will be zero when the modulation is exactly centered on the optimum ratio. When odd frequency components are detected, the adjusting means adjust the average of the ratio such that the modulation is performed substantially symmetrically around the resonance value. The phase of the odd frequency signal may be used to determine the direction of the feedback.

The modulation of the ratio may be effected by modulating the wavelength of the light beam or modulating the length of the optical cavity. Modulating the length of the optical cavity has the advantage that it can be done faster and more accurately. Modulating the wavelength of the light beam has the advantage that the detector does not need any moving parts, which is very advantageous for the manufacture of robust and small portable detectors.

In a preferred embodiment the transducer is a crystal oscillator. A crystal oscillator is much more sensitive than the microphone used in the above mentioned prior art system. Consequently, a more sensitive photo acoustic trace gas detector is obtained. As an additional advantage, the high sensitivity of the crystal oscillator makes the use of an acoustic cell unnecessary and thereby simplifies the construction of the detector.

In a further embodiment the crystal oscillator is a quartz tuning fork. Quartz tuning forks have a high accuracy. Furthermore, quartz tuning forks are not very expensive because they are used on large scale, for example, for the manufacturing of digital watches.

According to a second aspect of the invention, a method is provided comprising the steps of producing a light beam, transformation of the light beam into a series of light pulses for generating sound waves in the gas mixture, an amplitude of the sound waves being a measure of the concentration of the trace gas, amplification of light in an optical cavity containing the gas mixture, the optical cavity providing a maximum amplification when a ratio of a wavelength of the light beam and a length of the optical cavity has a resonance value, and converting the sound waves into electrical signals. The step of transformation comprises modulating the ratio.

These and other aspects of the invention are apparent from and will be elucidated with reference to the embodiments described hereinafter.

### BRIEF DESCRIPTION OF THE DRAWINGS

In the drawings:

FIG. 1 schematically shows an embodiment of the photo acoustic trace gas detector according to the invention,

FIG. 2 shows a dependence of the light intensity in the optical cavity on the length of the optical cavity,

FIG. 3a shows a time dependence of the light intensity in the optical cavity during modulation of the ratio, the modulation being performed symmetrically around the optimum value,

FIG. 3b shows a frequency spectrum of the measured light intensity shown in FIG. 3a,

FIG. 4a shows a time dependence of the light intensity in the optical cavity during modulation of the ratio, the modulation not being performed symmetrically around the optimum value,

FIG. 4b shows a frequency spectrum of the measured light intensity shown in FIG. 4a, and

FIG. 5 shows a flow diagram of a method according to the invention.

### DETAILED DESCRIPTION OF THE INVENTION

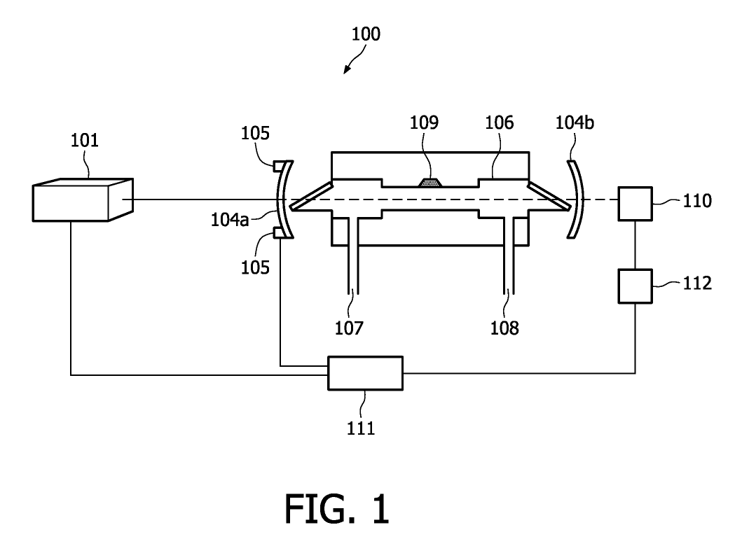

FIG. 1 shows a typical photo acoustic trace gas detector 100 according to the invention. A light source 101 provides a continuous wave light beam. Preferably, the light source 101 provides a laser beam. The light beam is sent into an optical cavity, which is defined by two semi-transparent mirrors 104a and 104b. The light beam enters the optical cavity through input mirror 104a and is reflected many times between the two cavity mirrors 104a and 104b. If the distance between the two mirrors 104a and 104b matches the wavelength of the laser, standing waves occur and the light intensity is amplified. An actuator, e.g. a piezo electric actuator 105, attached to one of the cavity mirrors 104a, 104b is used for modulating a length of the optical cavity. By modulation of the length of the optical cavity, the ratio of the laser wavelength and the cavity length is modulated. Maximum amplification of the light intensity is achieved at a resonance value for the ratio. Modulation electronics 111 control the actuator 105 and vary the cavity length around the length that provides maximum amplification at a frequency f. During each period of the modulation of the cavity length, the cavity length matches the wavelength of the light beam twice. Light pulses are generated at a frequency 2f. Alternatively, the modulation electronics 111 vary the ratio by varying the wavelength of the light beam, in which case the actuator 105 is not needed in the detector, or by varying both the cavity length and the wavelength.

The light that is transmitted by the output mirror 104b is measured with a photo detector 110. The signal from the photo detector 110 is used as a feedback signal for the wavelength of the light beam or the length of the optical cavity. If the modulation is performed exactly symmetrically around the optimum value, light pulses are generated at regular time intervals at a frequency 2f and the photo detector signal will only comprise amplitude components at the even multiples of the modulation frequency, f (2 f, 4 f, . . . , 2 n f). If the modulation is not performed exactly symmetrically around the optimum value, also odd multiples of frequency f (1 f, 3 f, . . . , (2n+1) f) will be comprised in the photo detector signal. These odd frequency components will be zero when the modulation is exactly centered on the optimum ratio. When odd frequency components are detected, the modulation electronics 111 are controlled by adjustment electronics 112 to adjust the average of the ratio such that the modulation is again performed substantially symmetrically around the resonance value.

Inside the optical cavity a gas cell 106 is situated for containing the gas mixture to be examined. Optionally, the gas cell 106 comprises a gas inlet 107 and a gas outlet 108 for allowing a gas flow through the gas cell 106. If the laser wavelength is tuned to a molecular transition, i.e. EI→EK, some of the molecules of the gas in the lower level EI will be excited into the upper level EK. By collisions with other atoms or molecules these excited molecules may transfer their excitation energy into translational, rotational, or vibrational energy of the collision partners. At thermal equilibrium this causes an increase of the thermal energy, resulting in a local rise of the temperature and pressure inside the gas cell 106. Every pulse of light will cause an increase in pressure after which the pressure can reduce again, before the next pulse arrives. This increase and decrease of pressure will result in an acoustic wave having twice the modulation frequency, as described above. Centered in the middle of the gas cell 106 is a transducer 109, e.g. a microphone that can pick up the acoustic wave generated by the absorbed light in the gas. Preferably, the transducer 109 is a crystal oscillator, e.g. a quartz tuning fork, with a resonance frequency that can pick up the acoustic wave generated by the absorbed light in the gas. The use of a crystal oscillator may make the acoustic cell used by Rossi et al. unnecessary.

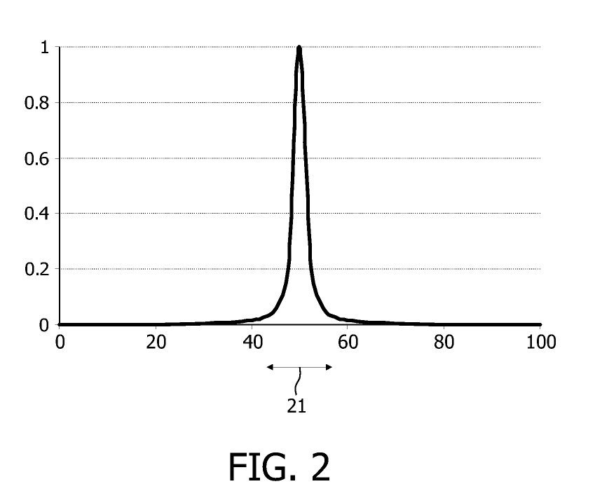

FIG. 2 shows a dependence of the light intensity (y-axis) in the optical cavity on the length of the optical cavity (x-axis). When the cavity length matches a multiple of the wavelength of the light beam, the light resonates inside the cavity and the optical power inside the cavity is increased. When the cavity length gets smaller or larger than the resonance length, the optical power in the cavity decreases to a fraction of the maximal power. The same effect can be obtained by varying the wavelength of the light beam, instead of or additionally to varying the cavity length.

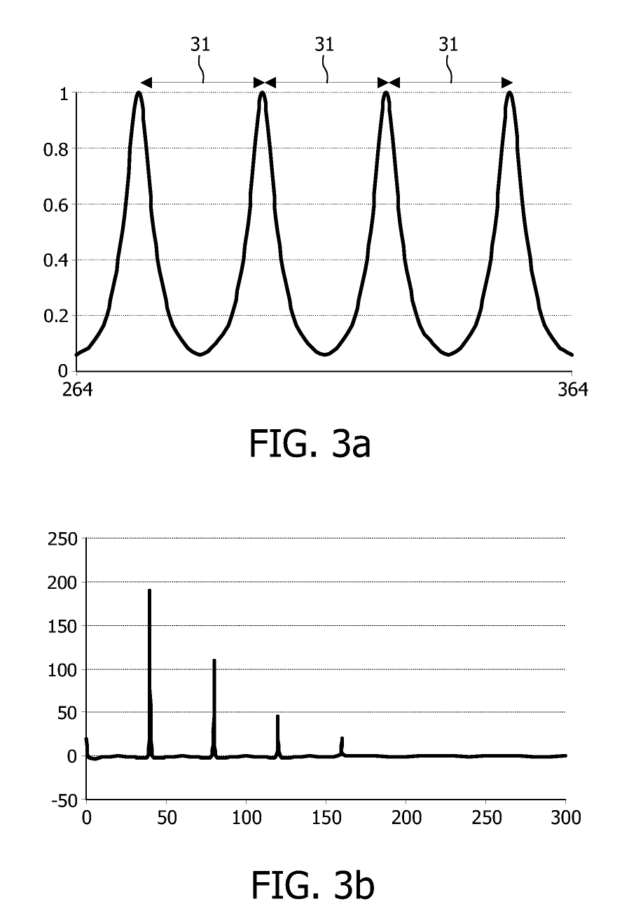

The modulation of the ratio is preferably performed such that the light intensity is varied between the minimal and the maximal value. It is preferable to perform the modulation over a range 21 with the resonance value in the center. Modulating around the resonance value allows for a stable feedback loop. When the cavity length is modulated at f=20 kHz with an amplitude of 5 (arbitrary units) around the resonance length of 50, the cavity will go in and out resonance. This results in a transmitted signal as depicted in FIG. 3a. FIG. 3a shows a time dependence (x-axis) of the light intensity (y-axis) in the optical cavity during modulation of the ratio. During each period of the modulation of the cavity length, the cavity length matches the multiple of the wavelength of the light beam twice; once when the cavity length goes from 45 to 55 and once when the cavity length goes from 55 back to 45. Light pulses are generated at a frequency 2f. Because the modulation is performed, symmetrically around the resonance value of the ratio, the peaks in the optical power occur at regular time intervals 31. As a result, also the pressure variations in the gas mixture are generated at regular time intervals. The transducer 109 detects the sound waves and converts them to electric signals comprising information about the concentration of the trace gas in the gas mixture.

FIG. 3b shows a frequency spectrum of the measured light intensity shown in FIG. 3a. The frequency spectrum is obtained by calculating the Fourier transform of the measured light intensity. In FIG. 3b, the amplitude components of the transmitted signal at multiples of the modulation frequency f are determined. If the modulation is performed exactly symmetrically around the optimum value, as is the case for the situation shown in FIG. 3a and 3b, light pulses are generated at regular time intervals at a frequency 2f and the photodiode signal will only comprise amplitude components at the even multiples of the modulation frequency f (2 f, 4 f, . . . , 2 n f).

Preferably, the modulation is performed such that the photodiode signal becomes approximately sinusoidal. As a result most of the power is concentrated in the lowest harmonic (2 f). This has the advantage that also most of the photo acoustic signal will be generated at this frequency. For photo acoustics this is important since the signal strength becomes weaker at higher frequencies.

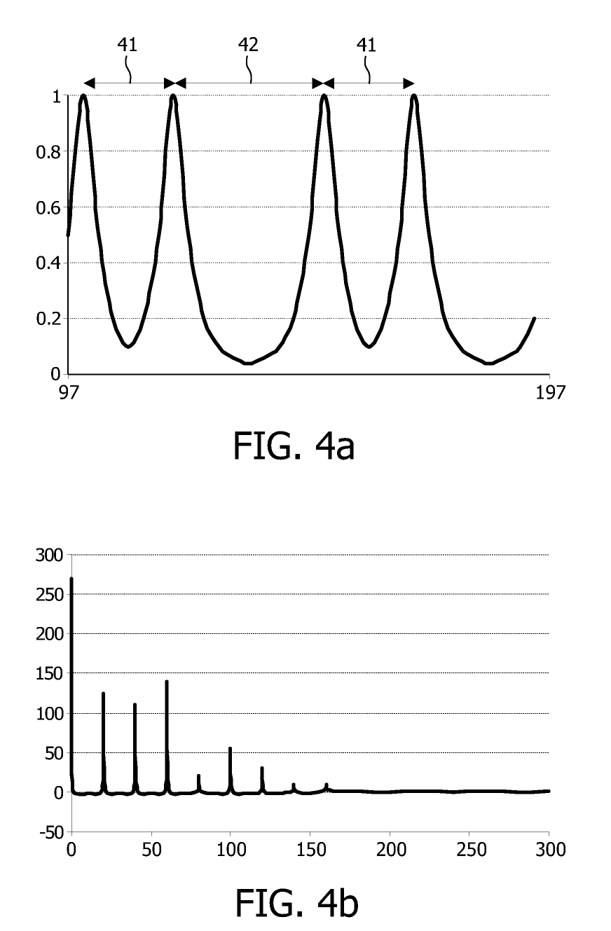

FIG. 4a shows a time dependence of the light intensity in the optical cavity during modulation of the ratio, the modulation not being performed symmetrically around the optimum value. In the example shown in FIG. 4a, an offset is given to the modulation range. The cavity length is modulated with an amplitude of 5 around length 52, while the resonance length is still 50 (see FIG. 2). The response of the transmitted signal is quite different from the response depicted in FIG. 3a. The signal becomes rather asymmetric which results in odd frequency components being present.

FIG. 4b shows a frequency spectrum of the measured light intensity shown in FIG. 4a. It is apparent from FIG. 4 b that due to the offset also odd multiples of the modulation frequency (f, 3 f, . . . , (2n+1) f) are comprised in the photodiode signal. When odd frequency components are detected, the adjustment electronics 112 adjust the average of the ratio such that the modulation is again performed substantially symmetrically around the resonance value. The resonance modulation band is found and kept by reducing the signal components measured at the odd frequencies. Any one or any combination of odd frequencies may be used to generate the error signal. When this signal goes to zero the optimum is position is found. The phase of this component with respect to the driving modulation provides the sign of the error signal. In the embodiments described above a Fourier transform has been performed for generating the error signal. A person skilled in the art would however also see that, e.g., electronic filters may be used, combined with a demodulation and phase sensitive detection to select certain frequency components and generate the feedback signal. Alternatively lock-in techniques may be used to measure the amplitude and phase of certain frequency components.

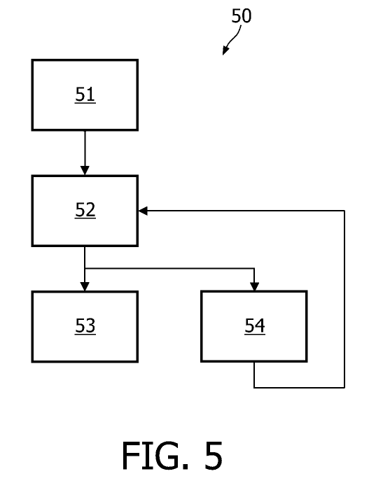

FIG. 5 shows a flow diagram of a method 50 according to the invention. The method 50 for detecting a concentration of a trace gas in a gas mixture comprises a light generating step 51 for producing a light beam. Preferably the light beam is a continuous wave laser beam at a wavelength tuned to a molecular transition in the trace gas molecules. The light beam is sent into an optical cavity. In a transformation step 52, the light beam is transformed into a series of light pulses for generating sound waves in the gas mixture. The amplitude of the sound waves is a measure of the concentration of the trace gas. The transformation is an effect of modulation of the cavity length, such that the light from the light beam alternately goes into and out of resonance. Preferably the modulation is performed around the resonance value of the cavity. The resonance results in amplification of the light in the optical cavity containing the gas mixture. If the difference between the highest and lowest intensity levels occurring in the cavity is large enough, the light pulses may cause pressure variations. The pressure variations are detected as sound waves in detection step 53 and converted into electric output signals representing the measured concentration of the trace gas. In feedback step 54, a photo diode 110 measures the light intensity behind the optical cavity and in dependence of the photo diode signal it is determined whether the modulation is performed exactly around the resonance value. If necessary, in dependence of the photo diode signal, the modulation of the cavity length in the transformation step 52 is adjusted to provide a more accurate trace gas detection 53.

It is to be noted that the advantageous combination of an optical cavity and a crystal oscillator could, in principal, also be achieved in trace gas detectors using different feedback loops and/or modulation schemes. When crystal oscillators are used instead of microphones it is important to use a modulation frequency that matches a resonance frequency of the crystal oscillator.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the claims enumerating several means, several of these means may be embodied by one and the same item of hardware. The mere fact that certain measures are recited in mutually different dependent claims does not indicate that a combination of these measures cannot be used to advantage. For example, elements described as a part of a playing piece made of a skeleton of polyhedrons, may also be used in playing pieces made of a honeycomb like structure and vice versa.

1. A photo acoustic trace gas detector (100) for detecting a concentration of a trace gas in a gas mixture, the photo acoustic trace gas detector (100) comprising
a light source (101) for producing a light beam,
an optical cavity (104a, 104b) for containing the gas mixture and for amplification of a light intensity of the light beam, the optical cavity (104a, 104b) providing a maximum amplification when a ratio of a wavelength of the light beam and a length of the optical cavity (104a, 104b) has a resonance value,
ratio modulating means (105, 111) for modulating the ratio, and
a transducer (109) for converting sound waves in the gas mixture into electrical signals,
characterized in that
the ratio modulating means (105, 111) are arranged for modulating the ratio for transformation of the light beam into a series of light pulses for generating the sound waves, an amplitude of the sound waves being a measure of the concentration of the trace gas.

2. A photo acoustic trace gas detector (100) as claimed in claim 1, wherein the ratio modulating means (105, 111) are arranged for modulating the ratio around the resonance value.

3. A photo acoustic trace gas detector (100) as claimed in claim 1, further comprising a feed back loop (110, 112) for regulating the amplification, the feedback loop comprising:
a photo detector (110) for measuring the light intensity of the light pulses, and
adjusting means (112), coupled to the photo detector (110) and to the ratio modulating means (111) for, in dependence of the measured light intensity, adjusting an average of the ratio such that the modulation is performed substantially symmetrically around the resonance value.

4. A photo acoustic trace gas detector (100) according to claim 3, wherein the adjusting means (112) are arranged for calculating frequency components of the measured light intensity.

5. A photo acoustic trace gas detector (100) according to claim 1, wherein the ratio modulating means (111) are arranged for modulating the wavelength of the light beam.

6. A photo acoustic trace gas detector (100) according to claim 1, wherein the ratio modulating means (105, 111) are arranged for modulating the length of the optical cavity.

7. A photo acoustic trace gas detector (100) as claimed in claim 1, wherein the transducer (109) is a crystal oscillator.

8. A photo acoustic trace gas detector (100) as claimed in claim 7, wherein the crystal oscillator is a quartz tuning fork.

9. A method for detecting a concentration of a trace gas in a gas mixture, the method comprising the steps of:
producing (51) a light beam,
transformation (52) of the light beam into a series of light pulses for generating sound waves in the gas mixture, an amplitude of the sound waves being a measure of the concentration of the trace gas,
amplification of light in an optical cavity containing the gas mixture, the optical cavity providing a maximum amplification when a ratio of a wavelength of the light beam and a length of the optical cavity has a resonance value, and
converting (53) the sound waves into electrical signals,
characterized in that
the step of transformation (52) comprises modulating the ratio.
